(19) United States
(12) Patent Application Publication
(10) Pub. No.: US 2023/0043735 A1
(43) Pub. Date: Feb. 9, 2023

(54) TECHNOLOGY TREND PREDICTION METHOD AND SYSTEM

(71) Applicant: BEIJING BENYING TECHNOLOGIES CO., LTD., Beijing (CN)

(72) Inventor: Yunfeng BAO, Beijing (CN)

(73) Assignee: BEIJING BENYING TECHNOLOGIES CO., LTD., Beijing (CN)

(21) Appl. No.: 17/787,942

(22) PCT Filed: Jan. 20, 2020
(86) PCT No.: PCT/CN2020/073296

§ 371 Date: Jun. 22, 2022

(30) Foreign Application Priority Data
Dec. 25, 2019 (CN) 201911358709.8

(51) Int. Cl. G06F 40/40; G06F 16/35; G06F 40/284; G06F 40/205

(52) U.S. Cl. CPC G06F 40/40; G06F 16/353; G06F 40/284; G06F 40/205

(57) ABSTRACT

A technology trend prediction method and system are provided. The method comprises acquiring paper data, and further comprises following steps: processing the paper data to generate a candidate technology lexicon; screening the candidate technology lexicon based on mutual information; calculating an independent word forming probability of an OOV word; extracting missed words in a title using a bidirectional long short-term memory network and a conditional random field (BI-LSTM+CRF) model; predicting a technology trend. The technology trend prediction method and system provided analyzes relationship of technology changes in a high-dimensional space, and predicts a development of technology trend based on time by extracting technical features of papers through natural language processing and time sequence algorithms.

### CROSS REFERENCES TO THE RELATED APPLICATIONS

This application is a national phase of International Patent Application No. PCT/CN2020/073296 filed on Jan. 20, 2020, which claims priority based on Chinese patent application No. 201911358709.8 filed on Dec. 25, 2019. The disclosures of the aforementioned applications are hereby incorporated by reference in their entireties.

### TECHNICAL FIELD

The present invention relates to the technical field of document analysis, in particular to a technology trend prediction method and system.

### BACKGROUND

With the increasing development of science and technology, there are more and more technical development directions, and the technical variation relationships are more and more complicated. At present there are several methods for determining technology trends, but these methods preform determination mostly according to opinions of an expert group, and these methods are complicated, and the time cost is large.

It is well known that the technology trend is accurately and effectively judged can reduce the technical judgment time, therefore, developing a technology trend prediction method and system is very promising.

The invention patent with publication No. CN106709021A discloses a technology trend prediction method and system. The system comprises a search module, a patent trend module, a business trend module and a prediction module; the search module is used for searching a plurality of patent data corresponding to a specific technology; the patent trend module is used for generating a first patent information according to the patent data; the business trend module is used for generating business trend information corresponding to the first patent information according to a plurality of target business data related to the patent data; the patent trend module is also used for generating a second patent information according to the business trend information, and generating a third patent information according to a plurality of predicted business data; and the prediction module is used for generating a technical trend prediction information according to the first patent information, the second patent information, and the third patent information. A disadvantage of this method is that it only predicts technology trend according to search and business trend, has a single dimension, and is difficult to embody value of one technology to other technologies.

### SUMMARY

In order to solve the above technical problems, a technology trend prediction method and system provided by the present invention analyzes relationship of technology changes in high-dimensional space, and predicts development of technology trend based on time by extracting technical features of papers through natural language processing and time series algorithms.

A first object of the present invention is to provide a technology trend prediction method, the method comprises acquiring paper data, and further comprises the following steps:

step 1: processing the paper data to generate a candidate technology lexicon;
step 2: screening the technology lexicon based on mutual information;
step 3: calculating an independent word forming probability of an OOV (out-of-vocabulary) word;
step 4: extracting missed words in a title by using a bidirectional long short-term memory network and a conditional random field (BI-LSTM+CRF) model;
step 5: predicting a technology trend.

Preferably, the step of acquiring paper data includes constructing a set of paper data.

In any of the above solutions, it is preferred that the step 1 includes performing part-of-speech filtering by using an existing part-of-speech tagging, and obtaining a preliminary lexicon after the part-of-speech filtering is completed.

In any of the above solutions, it is preferred that the step 1 further includes improving OOV word discovery of the technology lexicon by using a Hidden Markov Model (HMM) method.

In any of the above solutions, it is preferred that a formula of the HMM method is:

log{P(X|Y)P(Y)}=π(y₁)+Σ₂ⁿ{log{P(yᵢ|yᵢ₋₁)}+log{P(xᵢ|yᵢ)}}

wherein, x is an observation sequence, y is a state sequence, π(y₁) represents a probability that the first state is y₁, P represents a state transition probability, i represents the i-th state, and n represents the number of states.

In any of the above solutions, it is preferred that the step 2 includes calculating the mutual information of the OOV words, selecting a suitable threshold, and removing the OOV words with the mutual information lower than this threshold, a calculation formula is:

$${MI}_{s} = \frac{P ( {t}_{1} {t}_{2} … {t}_{i} )}{{\sum }_{i} P ( {t}_{i} ) - P P ( {t}_{1} {t}_{2} … {t}_{i} )} \approx \frac{\frac{f ( {t}_{1} {t}_{2} … {t}_{i} )}{L}}{\frac{{\sum }_{i} f ( {t}_{i} )}{L} - \frac{f ( {t}_{1} {t}_{2} … {t}_{i} )}{L}}$$

wherein, t₁ t₂ . . . tᵢ represents the OOV word, tᵢ represents characters forming the OOV word, f(t₁ t₂ . . . tᵢ) represents a frequency of the OOV word appearing in patent, L represents a total word frequency of all words in the patent, i represents the number of characters forming the OOV word, P(t₁ t₂ . . . tᵢ) represents a probability that the t₁ t₂ . . . tᵢ appears in the patent.

In any of the above solutions, it is preferred that the step 2 also includes that a result above is compensated with a word length when the frequency of long word is less than that of short word appearing in text, and a compensated result is:

$${MI}_{s} \approx \frac{f ( {t}_{1} {t}_{2} … {t}_{i} )}{{\sum }_{i} f ( {t}_{i} ) - f ( {t}_{1} {t}_{2} … {t}_{i} )} \times {N}_{i}$$

wherein, Nᵢ=i log₂ i.

In any of the above solutions, it is preferred that the step 3 includes selecting another suitable threshold, and removing the OOV words with the independent word forming probability lower than this threshold, formulas are as follows:

$$L d p = p ( Lpstr \vert str ) = \frac{p ( L p s t r )}{p ( s t r )} = \frac{f ( L p s t r )}{f ( s t r )}$$

$$Rdp = p ( Rpstr \vert str ) = \frac{p ( R p s t r )}{p ( s t r )} = \frac{f ( R p s t r )}{f ( s t r )}$$

$$Idp ( s t r ) = 1 - d p ( pstr \vert str ) = 1 - max \{ Ld p ( s t r ) , Rd p ( s t r ) \}$$

wherein, str represents a substring, pstr represents a parent string, Rpstr represents a right parent string, Lpstr represents a left parent string, p(⋅) represents the probability that a character string appears, f(⋅) represents the frequency of the character string, Ldp represents dependence of the substring on the left parent string, Rdp represents the dependence of the substring on the right parent string, Idp represents the independent word forming probability of the sub string, dp represents the dependence of the sub string on the parent string and is the maximum value of the Idp and the Rdp.

In any of the above solutions, it is preferred that a training method of the BI-LSTM+CRF model includes the following sub-steps:

step 41: constructing a labeled corpus according to the technology lexicon, taking the words in the title which also in the lexicon obtained in the step 3 as a training corpus of the model, taking the other words in the title as a predicted corpus of the model, and labeling the words in the title of the training corpus with B, I and O three types of tags, wherein B represents a beginning character of a new word, I represents an internal character of the new word, and O represents a non-technical noun word;
step 42: converting the words into word vectors, and then encoding them by using the BI-LSTM;
step 43: mapping an encoded result to a sequence vector with the dimension of the number of the tags through a fully connected layer;
step 44: decoding the sequence vector by the CRF.

In any of the above solutions, it is preferred that the step 4 further includes applying the trained BI-LSTM+CRF model to the predicted corpus, and extracting words labeled as B and I as new words discovered.

In any of the above solutions, it is preferred that the step 5 includes the following sub-steps:

step 51: extracting keywords of the paper data using the technology lexicon and an existing word segmentation system;
step 52: calculating word vectors of the extracted keywords in a high dimension to obtain xₜ∈ [symbol] ^{d}, wherein d is a spatial dimension, and [symbol] is a set of word vectors;
step 53: matching a technology word group w={w1,w2,w3 . . . } corresponding to a certain technology through a technical map, calculating correlated word of the word in the technology word group w in the paper data to obtain wt={w1t, w2t, w3t . . . }, wherein t is the time when the word appears for the first time in the paper;
step 54: performing K-means clustering for the correlated words generated after calculation to obtain the same or similar technology set;
step 55: obtaining a corresponding technical representation of the technology set using a weighted reverse maximum matching method, wherein different technology keywords have different weights in the technical map;
step 56: calculating the number of papers at different times for the technology by a Jaccard index to obtain a published time sequence of papers related with the technology, and a Jaccard index formula is:

$$( w 1 , w 2 ) = \frac{w 1 ⋂ w 2}{w 1 ⋃ w 2}$$

wherein, w1 is a keyword in the technology set, and w2 is a keyword in the paper;
step 57: calculating the technology trend by an ARIMA (Autoregressive Integrated Moving Average) model;
step 58: using an unweighted maximum matching and edge cutting algorithm, finally obtaining technology relevance without communication to calculate a technology change trend between technology clusters.

In any of the above solutions, it is preferred that the keywords are extracted using a weighted term frequency-inverse document frequency (TF-IDF) method, and a formula is:

$$weght ( {T}_{i j} ) = t {f}_{i j} \times i d {f}_{j} = \frac{{n}_{i j}}{{\sum }_{k} {n}_{k j}} \times log \frac{\vert D \vert}{\vert \{ j : {term}_{i} ∈ {d}_{j} \} \vert + 1}$$

wherein, Tᵢⱼ is a feature word, tfᵢⱼ is a feature word frequency, idfⱼ is an inverse document frequency, nᵢⱼ is the number of occurrences of the feature word in the paper dⱼ, k is the number of words in one paper, nₖⱼ is the total number of words in the paper dⱼ, D is the total number of all papers in the corpus, |{j: termᵢ∈dⱼ}| is the number of documents containing the feature word termᵢ.

In any of the above solutions, it is preferred that a formula of the clustering is:

$${c}^{( i )} := arg {min}_{j} {‖ {x}^{( i )} - {μ}_{j} ‖}^{2}$$

wherein, x is a technology word group vector, μ is a technology core word vector.

In any of the above solutions, it is preferred that a formula for calculating the technology trend is:

$$( 1 - {\sum }_{i = 1}^{p} {ϕ}_{i} {L}^{i} ) {( 1 - L )}^{d} {X}_{t} = ( 1 + {\sum }_{i = 1}^{q} {θ}_{i} {L}^{i} ) {ε}_{t}$$

wherein, p is an autoregressive term, ϕ is a slope coefficient, L is a lag operator, d is a fractional order, X is a technical correlation, q is a corresponding number of moving average terms, θ is a moving average coefficient, ε is a technical coefficient.

A second object of the present invention is to provide a technology trend prediction system, the system comprises an acquisition module used for acquiring paper data, and further comprises the following modules:

a processing module, used for processing the paper data to generate a candidate technology lexicon;
a screening module, used for screening the technology lexicon based on mutual information; a calculation module, used for calculating an independent word forming probability of an 00V (out-of-vocabulary) word;
an extraction module, used for extracting missed words in a title by using a bidirectional long short-term memory network and a conditional random field (BI-LSTM+CRF) model;
a prediction module, used for predicting a technology trend.

Preferably, the acquisition module is also used for constructing a set of paper data.

In any of the above solutions, it is preferred that the processing module is also used for performing part-of-speech filtering by using an existing part-of-speech tagging, and obtaining a preliminary lexicon after the part-of-speech filtering is completed.

In any of the above solutions, it is preferred that the processing module is also used for improving OOV word discovery of the technology lexicon by using a Hidden Markov Model (HMM) method.

In any of the above solutions, it is preferred that a formula of the HMM method is:

log{P(X|Y)P(Y)}=π(y₁)+Σ₂ⁿ{log{P(yᵢ|yᵢ₋₁)}+log{P(xᵢ|yᵢ)}}

wherein, x is an observation sequence, y is a state sequence, π(y₁) represents a probability that the first state is y₁, P represents a state transition probability, i represents the i-th state, and n represents the number of states.

In any of the above solutions, it is preferred that the screening module is also used for calculating the mutual information of the OOV words, selecting a suitable threshold, and removing the OOV words with the mutual information lower than this threshold, a calculation formula is:

$${MI}_{s} = \frac{P ( {t}_{1} {t}_{2} … {t}_{i} )}{{\sum }_{i} P ( {t}_{i} ) - P P ( {t}_{1} {t}_{2} … {t}_{i} )} \approx \frac{\frac{f ( {t}_{1} {t}_{2} … {t}_{i} )}{L}}{\frac{{\sum }_{i} f ( {t}_{i} )}{L} - \frac{f ( {t}_{1} {t}_{2} … {t}_{i} )}{L}}$$

wherein, t₁ t₂ . . . tᵢ represents the OOV word, tᵢ represents characters forming the OOV word, f(t₁ t₂ . . . tᵢ) represents a frequency of the OOV word appearing in patent, L represents a total word frequency of all words in the patent, i represents the number of characters forming the OOV word, P(t₁ t₂ . . . tᵢ) represents a probability that the t₁ t₂ . . . tᵢ appears in the patent.

In any of the above solutions, it is preferred that the screening module is also used for that a result above is compensated with a word length when the frequency of long word is less than that of short word appearing in text, and a compensated result is:

$${MI}_{s} \approx \frac{f ( {t}_{1} {t}_{2} … {t}_{i} )}{{\sum }_{i} f ( {t}_{i} ) - f ( {t}_{1} {t}_{2} … {t}_{i} )} \times {N}_{i}$$

wherein, Nᵢ=i log₂ i.

In any of the above solutions, it is preferred that the calculation module is also used for selecting another suitable threshold, and removing the OVV words with the independent word forming probability lower than this threshold, formulas are as follows:

$$L d p = p ( Lpstr \vert str ) = \frac{p ( L p s t r )}{p ( s t r )} = \frac{f ( L p s t r )}{f ( s t r )}$$

$$Rdp = p ( Rpstr \vert str ) = \frac{p ( R p s t r )}{p ( s t r )} = \frac{f ( R p s t r )}{f ( s t r )}$$

$$Idp ( s t r ) = 1 - d p ( pstr \vert str ) = 1 - max \{ Ld p ( s t r ) , Rd p ( s t r ) \}$$

wherein, str represents a substring, pstr represents a parent string, Rpstr represents a right parent string, Lpstr represents a left parent string, p(⋅) represents the probability that a character string appears, f(⋅) represents the frequency of the character string, Ldp represents dependence of the substring on the left parent string, Rdp represents the dependence of the substring on the right parent string, Idp represents the independent word forming probability of the sub string, dp represents the dependence of the sub string on the parent string and is the maximum value of the Idp and the Rdp.

In any of the above solutions, it is preferred that a training method of the BI-LSTM+CRF model includes the following sub-steps:

step 41: constructing a labeled corpus according to the technology lexicon, taking the words in the title which also in the lexicon obtained in the step 1 to the step 3 as a training corpus of the model, taking the other words in the title as a predicted corpus of the model, and labeling the words in the title of the training corpus with B, I and O three types of tags, wherein B represents a beginning character of a new word, I represents an internal character of the new word, and O represents a non-technical noun word;
step 42: converting the words into word vectors, and then encoding them by using the BI-LSTM;
step 43: mapping an encoded result to a sequence vector with the dimension of the number of the tags through a fully connected layer;
step 44: decoding the sequence vector by the CRF.

In any of the above solutions, it is preferred that the extraction module is also used for applying the trained BI-LSTM+CRF model to the predicted corpus, and extracting words labeled as B and I as new words discovered.

In any of the above solutions, it is preferred that an operation of the prediction module includes the following sub-steps:

step 51: extracting keywords of the paper data using the technology lexicon and an existing word segmentation system;
step 52: calculating word vectors of the extracted keywords in a high dimension to obtain xₜϵ [symbol] ^{d}, wherein d is a spatial dimension, and [symbol] is a set of word vectors;
step 53: matching a technology word group w={w1,w2,w3 . . . } corresponding to a certain technology through a technical map, calculating correlated word of the word in the technology word group w in the paper data to obtain wt={w1t, w2t, w3t . . . }, wherein t is the time when the word appears for the first time in the paper;
step 54: performing K-means clustering for the correlated words generated after calculation to obtain the same or similar technology set;
step 55: obtaining a corresponding technical representation of the technology set using a weighted reverse maximum matching method, wherein different technology keywords have different weights in the technical map;
step 56: calculating the number of papers at different times for the technology by a Jaccard index to obtain a published time sequence of papers related with the technology, and a Jaccard index formula is:

$$( w 1 , w 2 ) = \frac{w 1 ⋂ w 2}{w 1 ⋃ w 2}$$

wherein, w1 is a keyword in the technology set, and w2 is a keyword in the paper;
step 57: calculating the technology trend by an ARIMA (Autoregressive Integrated Moving Average) model;
step 58: using an unweighted maximum matching and edge cutting algorithm, finally obtaining technology relevance without communication to calculate a technology change trend between technology clusters.

In any of the above solutions, it is preferred that the keywords are extracted using a weighted term frequency-inverse document frequency (TF-IDF), and a formula is:

$$weght ( {T}_{i j} ) = t {f}_{i j} \times i d {f}_{j} = \frac{{n}_{i j}}{{\sum }_{k} {n}_{k j}} \times log \frac{\vert D \vert}{\vert \{ j : {term}_{i} ∈ {d}_{j} \} \vert + 1}$$

wherein, Tᵢⱼ is a feature word, tfᵢⱼ is a feature word frequency, idfⱼ is an inverse document frequency, nᵢⱼ is the number of occurrences of the feature word in the paper dⱼ, k is the number of words in one paper, nₖⱼ is the total number of words in the paper dⱼ, D is the total number of all papers in the corpus, |{j: termᵢ∈dⱼ}| is the number of documents containing the feature word termᵢ.

In any of the above solutions, it is preferred that a formula of the clustering is:

$${c}^{( i )} := arg {min}_{j} {‖ {x}^{( i )} - {μ}_{j} ‖}^{2}$$

wherein, x is a technology word group vector, μ is a technology core word vector.

In any of the above solutions, it is preferred that a formula for calculating the technology trend is:

$$( 1 - {\sum }_{i = 1}^{p} {ϕ}_{i} {L}^{i} ) {( 1 - L )}^{d} {X}_{t} = ( 1 + {\sum }_{i = 1}^{q} {θ}_{i} {L}^{i} ) {ε}_{t}$$

wherein, p is an autoregressive term, ϕ is a slope coefficient, L is a lag operator, d is a fractional order, X is a technical correlation, q is a corresponding number of moving average terms, θ is a moving average coefficient, ε is a technical coefficient.

The present invention provides the technology trend prediction method and system, which can objectively analyze the relationship between the technologies, predict the technology trend, and judge the technology development direction, etc.

### BRIEF DESCRIPTION OF THE DRAWINGS

FIG. 1 is a flowchart of a preferred embodiment of a technology trend prediction method according to the present invention.

FIG. 1A is a flowchart of a training method of a model in the embodiment shown in FIG. 1 according to the technology trend prediction method of the present invention.

FIG. 1B is a flowchart of a technology trend prediction method in the embodiment shown in FIG. 1 according to the technology trend prediction method of the present invention.

FIG. 2 is a module diagram of a preferred embodiment of a technology trend prediction system according to the present invention.

FIG. 3 is a model mechanism diagram of a preferred embodiment of the technology trend prediction method according to the present invention.

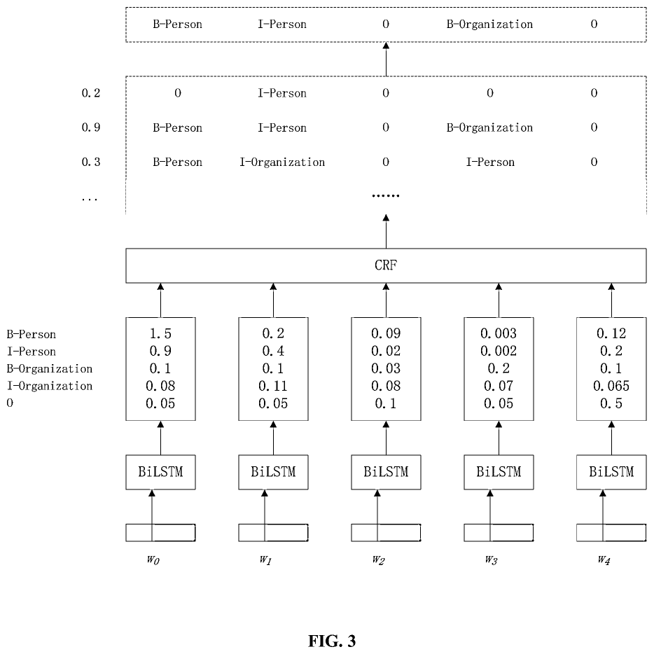

### DETAILED DESCRIPTION OF THE EMBODIMENTS

Further description of the present invention is provided below with reference to specific embodiments and drawings.

### Embodiment 1

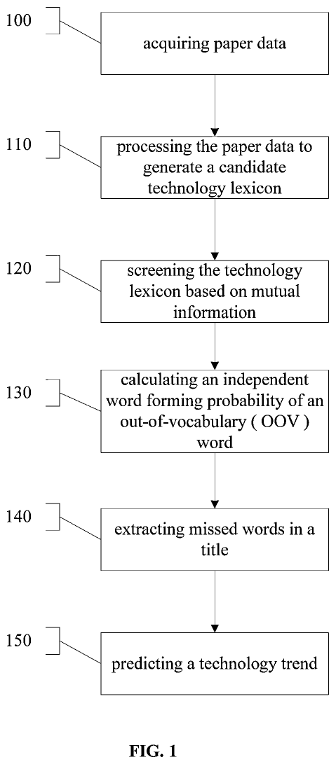

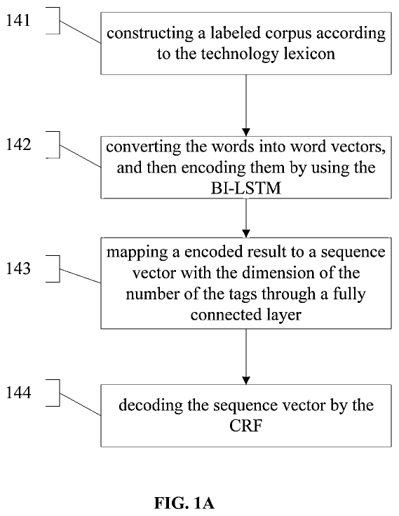

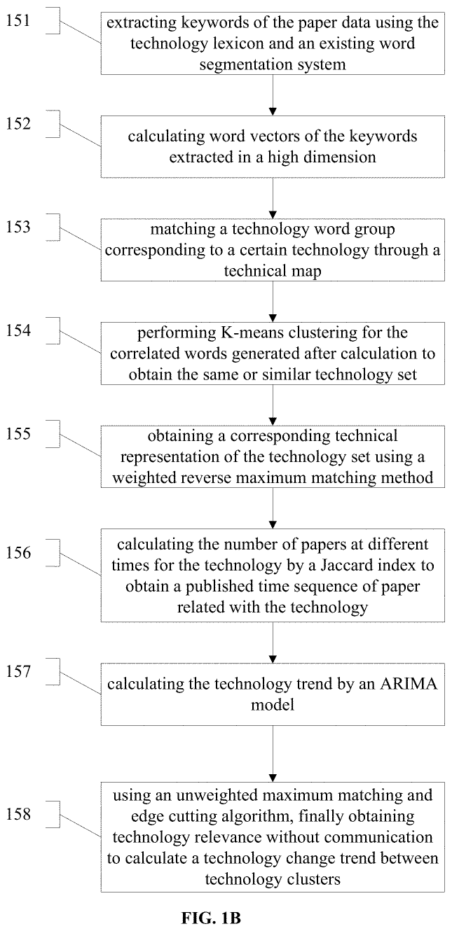

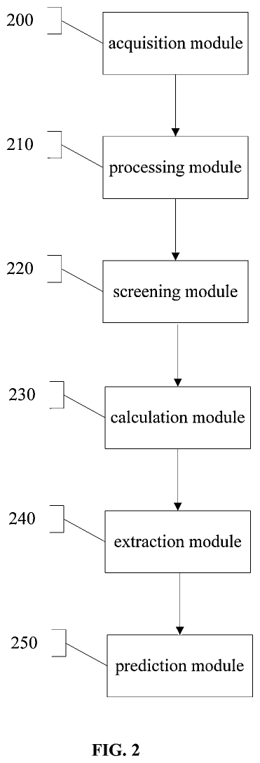

As shown in FIG. 1 and FIG. 2, step 100 is performed, an acquisition module 200 acquires paper data and construct a set of paper data.

Step 110 is performed to process the paper data to generate a candidate technology lexicon using a processing module 210. Part-of-speech filtering is performed by using an existing part-of-speech tagging, and a preliminary lexicon is obtained after the part-of-speech filtering is completed. OOV (out-of-vocabulary) word discovery of the technology lexicon is improved by using a Hidden Markov Model (HMM) method. A formula of the HMM method is:

$$log \{ P ( X \vert Y ) P ( Y ) \} = π ( {y}_{1} ) + {\sum }_{2}^{n} \{ log \{ P ( {y}_{i} \vert {y}_{i - 1} ) \} + log \{ P ( {x}_{i} \vert {y}_{i} ) \} \}$$

wherein, x is an observation sequence, y is a state sequence, π(y₁) represents a probability that the first state is y₁, P represents a state transition probability, i represents the i-th state, and n represents the number of states.

Step 120 is performed to screen the technology lexicon based on mutual information using a screening module 220. The mutual information of the OOV words is calculated, a suitable threshold is selected, and the OOV words with the mutual information lower than this threshold is removed, and a calculation formula is:

$${MI}_{s} = \frac{P ( {t}_{1} {t}_{2} … {t}_{i} )}{{\sum }_{i} P ( {t}_{i} ) - P P ( {t}_{1} {t}_{2} … {t}_{i} )} \approx \frac{\frac{f ( {t}_{1} {t}_{2} … {t}_{i} )}{L}}{\frac{{\sum }_{i} f ( {t}_{i} )}{L} - \frac{f ( {t}_{1} {t}_{2} … {t}_{i} )}{L}}$$

wherein, t₁ t₂ . . . tᵢ represents the OOV word, tᵢ represents characters forming the OOV word, f(t₁ t₂ . . . tᵢ) represents a frequency of the OOV word appearing in patent, L represents a total word frequency of all words in the patent, i represents the number of characters forming the OOV word, P(t₁ t₂ . . . tᵢ) represents a probability that the t₁ t₂ . . . tᵢ appears in the patent.

A result above is compensated with a word length when the frequency of long word is less than the that of short word appearing in text, and the compensated result is:

$${MI}_{s} \approx \frac{f ( {t}_{1} {t}_{2} … {t}_{i} )}{{\sum }_{i} f ( {t}_{i} ) - f ( {t}_{1} {t}_{2} … {t}_{i} )} \times {N}_{i}$$

wherein, Nᵢ=i log₂ i.

Step 130 is performed to calculate an independent word forming probability of the OOV words using a calculation module 230. Another suitable threshold is selected, and the OOV words with the independent word forming probability lower than this threshold are removed, formulas are as follows:

$$L d p = p ( Lpstr \vert str ) = \frac{p ( L p s t r )}{p ( s t r )} = \frac{f ( L p s t r )}{f ( s t r )}$$

$$Rdp = p ( Rpstr \vert str ) = \frac{p ( R p s t r )}{p ( s t r )} = \frac{f ( R p s t r )}{f ( s t r )}$$

$$Idp ( s t r ) = 1 - d p ( pstr \vert str ) = 1 - max \{ Ld p ( s t r ) , Rd p ( s t r ) \}$$

wherein, str represents a substring, pstr represents a parent string, Rpstr represents a right parent string, Lpstr represents a left parent string, p(⋅) represents the probability that a character string appears, f(⋅) represents the frequency of the character string, Ldp represents dependence of the substring on the left parent string, Rdp represents the dependence of the substring on the right parent string, Idp represents the independent word forming probability of the sub string, dp represents the dependence of the sub string on the parent string and is the maximum value of the Idp and the Rdp.

Step 140 is performed, and an extraction module 240 extracts missed words in a title by using a bidirectional long short-term memory network BI-LSTM and a conditional random field CRF (BI-LSTM+CRF) model.

As shown in FIG. 1A, a training method of the BI-LSTM+CRF model includes the following sub-steps. Step 141 is performed to construct a labeled corpus according to the technology lexicon, take the words in the title which also in the lexicon obtained in the step 3 as a training corpus of the model, take the other words in the title as a predicted corpus of the model, and label the words in the title of the training corpus with B, I and O three types of tags, wherein B represents a beginning character of new word, I represents an internal character of the new word, and O represents a non-technical noun word. Step 142 is performed to convert the words into word vectors, and then encode them by using the BI-LSTM. Step 143 is performed to map an encoded result to a sequence vector with the dimension of the number of the tags through a fully connected layer. Step 144 is performed to decode the sequence vector by the CRF. The trained BI-LSTM+CRF model is applied to the predicted corpus, and words labeled as B and I are extracted as new words discovered.

Step 150 is performed to predict a technology trend using a prediction module 250. As shown in FIG. 1B, in this step, step 151 is performed to extract keywords of the paper data using the technology lexicon and an existing word segmentation system. The keywords are extracted using a weighted term frequency-inverse document frequency (TF-IDF) method, and a formula is:

$$weght ( {T}_{i j} ) = t {f}_{i j} \times i d {f}_{j} = \frac{{n}_{i j}}{{\sum }_{k} {n}_{k j}} \times log \frac{\vert D \vert}{\vert \{ j : {term}_{i} ∈ {d}_{j} \} \vert + 1}$$

wherein, Tᵢⱼ is a feature word, tfᵢⱼ is a feature word frequency, idfⱼ is an inverse document frequency, nᵢⱼ is the number of occurrences of the feature word in the paper dⱼ, k is the number of words in one paper, nₖⱼ is the total number of words in the paper dⱼ, D is the total number of all papers in the corpus, |{j: termᵢ∈d₁}| is the number of documents containing the feature word termᵢ.

Step 152 is performed to calculate word vectors of the extracted keywords in a high dimension to obtain xₜϵ [symbol] ^{d}, wherein d is a spatial dimension, and [symbol] is a set of word vectors.

Step 153 is performed to match a technology word group w={w1,w2,w3 . . . } corresponding to a certain technology through a technical map, calculate correlated word of the word in the technology word group w in the paper data, and obtain wt={w1t, w2t, w3t . . . }, wherein t is the time when the word appears for the first time in the paper.

Step 154 is performed to perform K-means clustering for the correlated words generated after calculation to obtain the same or similar technology set. A formula of the clustering is:

$${c}^{( i )} := arg {min}_{j} {‖ {x}^{( i )} - {μ}_{j} ‖}^{2}$$

wherein, x is a technology word group vector, μ is a technology core word vector.

Step 155 is performed to obtain a corresponding technical representation of the technology set using a weighted reverse maximum matching method, wherein different technology keywords have different weights in the technical map.

Step 156 is performed to calculate the number of papers at different times for the technology by a Jaccard index to obtain a published time sequence of papers related with the technology, and a Jaccard index formula is:

$$( w 1 , w 2 ) = \frac{w 1 ⋂ w 2}{w 1 ⋃ w 2}$$

wherein, w1 is a keyword in the technology set, and w2 is a keyword in the paper.

Step 157 is performed to calculate the technology trend by an ARIMA (Autoregressive Integrated Moving Average) model. A formula for calculating the technology trend:

$$( 1 - {\sum }_{i = 1}^{p} {ϕ}_{i} {L}^{i} ) {( 1 - L )}^{d} {X}_{t} = ( 1 + {\sum }_{i = 1}^{q} {θ}_{i} {L}^{i} ) {ε}_{t}$$

wherein, p is an autoregressive term, ϕ is a slope coefficient, L is a lag operator, d is a fractional order, X is a technical correlation, q is a corresponding number of moving average terms, θ is a moving average coefficient, ε is a technical coefficient.

Step 158 is performed to use an unweighted maximum matching and edge cutting algorithm, finally obtain technology relevance without communication to calculate a technology change trend between technology clusters.

### Embodiment 2

The present invention comprises the following steps.

The first step: processing a technology lexicon.

a) Step 1: acquiring paper data to construct a set of paper data.

b) Step 2: generating a candidate technology lexicon. A specific realization method is: performing part-of-speech filtering by using an existing part-of-speech tagging, and obtaining a preliminary lexicon after the part-of-speech filtering is completed, a method of the part-of-speech filtering is as follow:

| two-word terms | three-word terms |
|---|---|
| N + N | N + N + N |
| N + V | V + N + N |
| V + N | N + V + N |
| A + N | V + V + N |
| D + N | B + V + N |
| B + N | N + M + N |

wherein, N represents a noun, V represents a verb, B represents a distinguishing word, A represents an adjective, D represents a adverb, M represents a numeral, and a multi-word term is generated by different combinations of part-of-speech.

c) Step 3: improving OOV word discovery of the technology lexicon using a Hidden Markov Model (HMM) method, a formula of the HMM method is:

$$log \{ P ( X \vert Y ) P ( Y ) \} = π ( {y}_{1} ) + {\sum }_{2}^{n} \{ log \{ P ( {y}_{i} \vert {y}_{i - 1} ) \} + log \{ P ( {x}_{i} \vert {y}_{i} ) \} \}$$

wherein, x is an observation sequence, y is a state sequence, π(y₁) represents a probability that the first state is

d) Step 4: screening the lexicon generated above using a mutual information method. The mutual information of the OOV words is calculated, a suitable threshold is selected, and the OOV words with the mutual information lower than this threshold are removed, and a formula is:

$${MI}_{s} = \frac{P ( {t}_{1} {t}_{2} … {t}_{i} )}{{\sum }_{i} P ( {t}_{i} ) - P P ( {t}_{1} {t}_{2} … {t}_{i} )} \approx \frac{\frac{f ( {t}_{1} {t}_{2} … {t}_{i} )}{L}}{\frac{{\sum }_{i} f ( {t}_{i} )}{L} - \frac{f ( {t}_{1} {t}_{2} … {t}_{i} )}{L}}$$

wherein, t₁ t₂ . . . tᵢ represents the OOV word, tᵢ represents the characters forming the OOV word, f(t₁ t₂ . . . tᵢ) represents a frequency of the OOV word appearing in patent, L represents a total word frequency of all words in the patent, i represents the number of characters forming the OOV word, P(t₁ t₂ . . . tᵢ) represents a probability that the t₁ t₂ . . . tᵢ appears in the patent.

According to a statistical result, the frequency of the long word is less than that of short word appearing in text, so a result above is compensated with a word length, and the compensated result is:

$${MI}_{s} \approx \frac{f ( {t}_{1} {t}_{2} … {t}_{i} )}{{\sum }_{i} f ( {t}_{i} ) - f ( {t}_{1} {t}_{2} … {t}_{i} )} \times {N}_{i}$$

wherein, Nᵢ=i log₂ i.

e) Step 5: reducing broken strings in the lexicon generated above. An independent word forming probability of an OOV word is calculated, another suitable threshold is selected, and the OOV words with independent word forming probability lower than this threshold are removed, a formula is:

$$L d p = p ( Lpstr \vert str ) = \frac{p ( L p s t r )}{p ( s t r )} = \frac{f ( L p s t r )}{f ( s t r )}$$

$$Rdp = p ( Rpstr \vert str ) = \frac{p ( R p s t r )}{p ( s t r )} = \frac{f ( R p s t r )}{f ( s t r )}$$

$$Idp ( s t r ) = 1 - d p ( pstr \vert str ) = 1 - max \{ Ld p ( s t r ) , R d p ( s t r ) \}$$

wherein, str represents a substring, pstr represents a parent string, Rpstr represents a right parent string, Lpstr represents a left parent string, p(⋅) represents the probability that a character string appears, f(⋅) represents the frequency of the character string, Ldp represents dependence of the substring on the left parent string, Rdp represents the dependence of the substring on the right parent string, Idp represents the independent word forming probability of the sub string.

f) Step 6: extracting missed words in a title after the above steps to improve a recall rate using a BI-LSTM+CRF model:1. i. constructing a labeled corpus according to the technology lexicon obtained after the above steps, taking the words in the title which also in the lexicon as a training corpus of the model, taking the other words in the title as a predicted corpus of the model, and labeling the words in the title of the training corpus with B, I and O three types of tags, wherein B represents a beginning character of new word, I represents an internal character of the new word, and O represents a non-technical noun word;

ii. converting the words into word vectors, and then encoding them by using the BI-LSTM;
iii. mapping an encoded result to a sequence vector with the dimension of the number of the tags through a fully connected layer;
iv. decoding the sequence vector obtained above by the CRF;
v. training a model according to the above steps, and then applying the trained BI-LSTM+CRF model to the predicted corpus, and extracting words labeled as B and I e as new words discovered.

The second step: predicting a technology trend.

a). Keywords of the paper data are extracted using the technology lexicon generated in the first step and an existing word segmentation system; the keywords are extracted using a weighted (TF-IDF) method, and a formula is:

$$weght ( {T}_{i j} ) = t {f}_{i j} \times i d {f}_{j} = \frac{{n}_{i j}}{{\sum }_{k} {n}_{k j}} \times log \frac{\vert D \vert}{\vert \{ j : {term}_{i} ∈ {d}_{j} \} \vert + 1}$$

$$f ( w ) = t ( w ) + title ( w ) + t e c ( w ) ,$$

$$title ( w ) = \{ \begin{matrix}5 , w in the title \\ 0 , no w in the title\end{matrix} ,$$

$$tec ( w ) = \{ \begin{matrix}3 , w in the title \\ 0 , no w in the title\end{matrix}$$

wherein, t(w)=weight(Tᵢⱼ) is a TF-IDF value of a feature Tᵢⱼ in a document dⱼ; title(w) is the weight of the word w when the word w appears in the title, and tec(w) is the weight of the word w when the word w appears in the technology field.

b). Word vectors of the extracted keywords in a high dimension are calculated to obtain xₜϵ [symbol] ^{d}, wherein d is a spatial dimension.

c). A technology word group w={w1,w2,w3 . . . } corresponding to a certain technology is matched through a technical map, and then correlated word of the word in the technology word group w in the paper data is calculated to obtain wt={w1t, w2t, w3t . . . }, wherein t is the time when the word appears for the first time in the paper.

d). K-means clustering is performed for the correlated words generated after calculation to obtain the same or similar technology set:

$${c}^{( i )} := arg {min}_{j} {‖ {x}^{( i )} - {μ}_{j} ‖}^{2} .$$

e). A corresponding technical representation of the technology set is obtained by using a weighted reverse maximum matching method, wherein different technology keywords have different weights in the technical map.

f). The number of papers at different times for the technology is calculated to obtain a published time sequence of papers related with the technology.

g). the technology trend is calculated by a ARIMA model, and a formula is:

$$( 1 - {\sum }_{i = 1}^{p} {ϕ}_{i} {L}^{i} ) {( 1 - L )}^{d} {X}_{t} = ( 1 + {\sum }_{i = 1}^{q} {θ}_{i} {L}^{i} ) {ε}_{t}$$

wherein, L is a lag operator, d is in Z and d>0.

h). An unweighted maximum matching and edge cutting algorithm is used to obtain technology relevance without communication, and a technology change trend between e technology clusters is calculated.

In order to better understand the present invention, the detailed description is made above in conjunction with the specific embodiments of the present invention, but it is not a limitation of the present invention. Any simple modification to the above embodiments based on the technical essence of the present invention still belongs to the scope of the technical solution of the present invention. Each embodiment in this specification focuses on differences from other embodiments, and the same or similar parts between the various embodiments can be referred to each other. As for the system embodiment, since it basically corresponds to the method embodiment, the description is relatively simple, and the relevant part can refer to the part of the description of the method embodiment.

1. A technology trend prediction method, comprising: acquiring paper data, the technology trend prediction method further comprises following steps:
step 1: processing the paper data to generate a candidate technology lexicon;
step 2: screening the candidate technology lexicon based on mutual information;
step 3: calculating an independent word forming probability of an out-of-vocabulary (OOV) word;
step 4: extracting missed words in a title using a bidirectional long short-term memory network and a conditional random field (BI-LSTM+CRF) model;
step 5: predicting a technology trend.

2. The technology trend prediction method according to claim 1, wherein the acquiring of the paper data further comprises constructing a set of paper data:
wherein step 1 further comprises
performing a part-of-speech filtering by using an existing part-of-speech tagging,
obtaining a preliminary lexicon after the part-of-speech filtering is completed, and
improving an OOV word discovery of the candidate technology lexicon by using a Hidden Markov Model (HMM) method;
wherein a formula of the HMM method is:
$$log \{ P ( X \vert Y ) P ( Y ) \} = π ( {y}_{1} ) + {\sum }_{2}^{n} \{ log \{ P ( {y}_{i} \vert {y}_{i - 1} ) \} + log \{ P ( {x}_{i} \vert {y}_{i} ) \} \}$$
wherein, x is an observation sequence, y is a state sequence, π(y₁) represents a probability that a first state is y₁, P represents a state transition probability, i represents an i-th state, and n represents a number of states.

3. (canceled)

4. (canceled)

5. (canceled)

6. The technology trend prediction method according to claim 2, wherein step 2 further comprises calculating the mutual information of the OOV words, selecting a first threshold, and removing the OOV words with the mutual information lower than the first threshold, and a calculation formula is:
$${MI}_{s} = \frac{P ( {t}_{1} {t}_{2} … {t}_{i} )}{{\sum }_{i} P ( {t}_{i} ) - PP ( {t}_{1} {t}_{2} … {t}_{i} )} \approx \frac{\frac{f ( {t}_{1} {t}_{2} … {t}_{i} )}{L}}{\frac{{\sum }_{i} f ( {t}_{i} )}{L} - \frac{f ( {t}_{1} {t}_{2} … {t}_{i} )}{L}}$$
wherein, t₁ t₂ . . . tᵢ represents the OOV word, tᵢ represents characters forming the OOV word, f(t₁ t₂ . . . tᵢ) represents a frequency of the OOV word appearing in a patent, L represents a total word frequency of all words in the patent, i represents the number of characters forming the OOV word, and P(t₁ t₂ . . . tᵢ) represents a probability that the t₁ t₂ . . . tᵢ appears in the patent; and
step 2 further comprises
compensating a result of the calculation formula with a word length when a frequency of long words is less than a frequency of short words appearing in the patent, wherein a compensated result is:
$$\underline{{MI}_{s} \approx \frac{f ( {t}_{1} {t}_{2} … {t}_{i} )}{{\sum }_{i} f ( {t}_{i} ) - f ( {t}_{1} {t}_{2} … {t}_{i} )} \times {N}_{i}}$$
wherein, Nᵢ=i log₂ i.

7. (canceled)

8. The technology trend prediction method according to claim 6, wherein step 3 further comprises selecting a second threshold, and removing the OOV words with the independent word forming probability lower than the second suitable threshold, formulas are as follows:
$$Ldp = p ( Lpstr \vert str ) = \frac{p ( Lpstr )}{p ( str )} = \frac{f ( Lpstr )}{f ( str )} \\ Rdp = p ( Rpstr \vert str ) = \frac{p ( Rpstr )}{p ( str )} = \frac{f ( Rpstr )}{f ( str )} \\ Idp ( str ) = 1 - dp ( pstr \vert str ) = 1 - max \{ Ldp ( str ) , Rdp ( str ) \}$$
wherein, str represents a substring, pstr represents a parent string, Rpstr represents a right parent string, Lpstr represents a left parent string, p(⋅) represents a probability that a character string appears, f(⋅) represents a frequency of the character string, Ldp represents dependence of the sub string on the left parent string, Rdp represents the dependence of the substring on the right parent string, Idp represents the independent word forming probability of the substring, and dp represents the dependence of the substring on the parent string and is a maximum value of the Idp and the Rdp.

9. The technology trend prediction method according to claim 8, wherein a training method of the BI-LSTM+CRF model comprises following sub-steps:
step 41: constructing a labeled corpus according to a technology lexicon, taking words in a title and also in the technology lexicon obtained in step 3 as a training corpus of the BI-LSTM+CRF model, taking the other words in the title as a predicted corpus of the BI-LSTM+CRF model, and labeling the words in the title of the training corpus with B, I, and O, three types of tags, wherein B represents a beginning character of a new word, I represents an internal character of the new word, and O represents a non-technical noun word;
step 42: converting the words into word vectors, and encoding the word vectors by using the BI-LSTM model;
step 43: mapping an encoded result to a sequence vector with a dimension of a number of the tags through a fully connected layer; and
step 44: decoding the sequence vector by the CRF model;
wherein step 4 further comprises applying the trained BI-LSTM+CRF model to the predicted corpus, and extracting words labeled as B and I as new words discovered.

10. (canceled)

11. The technology trend prediction method according to claim 1, wherein step 5 further comprises following sub-steps:
step 51: extracting keywords of the paper data using a technology lexicon and an existing word segmentation system;
step 52: calculating word vectors of the extracted keywords in a high dimension to obtain Xₜϵ [symbol] ^{d}, wherein d is a spatial dimension, and [symbol] is a set of word vector;
step 53: matching a technology word group w={w1,w2,w3 . . . } corresponding to a specific technology through a technical map, calculating correlated words of a word in the technology word group w in the paper data to obtain wt={w1t, w2t, w3t . . . }, wherein t is the time when the word appears for the first time in a paper;
step 54: performing K-means clustering for the correlated words generated after calculation to obtain a same or similar technology set;
step 55: obtaining a corresponding technical representation of the same or similar technology set using a weighted reverse maximum matching method, wherein different technical keywords have different weights in the technical map;
step 56: calculating a number of papers at different times for the specific technology by a Jaccard index to obtain a published time sequence of paper related with the specific technology, and a formula of the Jaccard index is:
$$( w 1 , w 2 ) = \frac{w 1 ⋂ w 2}{w 1 ⋃ w 2}$$
wherein, w1 is a keyword in the same or similar technology set, and w2 is a keyword in the paper;
step 57: calculating the technology trend by an ARIMA model;
step 58: using an unweighted maximum matching and edge cutting algorithm to obtain a technology relevance without a communication to calculate a technology change trend between technology clusters.

12. The technology trend prediction method according to claim 11, wherein the keywords are extracted using a weighted term frequency-inverse document frequency (TF-IDF) formula:
$$weght ( {T}_{ij} ) = {tf}_{ij} \times {idf}_{j} = \frac{{n}_{ij}}{{\sum }_{k} {n}_{kj}} \times log \frac{\vert D \vert}{\vert \{ j : {term}_{i} ∈ {d}_{j} \} \vert + 1}$$
wherein, Tᵢⱼ is a feature word, tfᵢⱼ is a feature word frequency, idfⱼ is an inverse document frequency, nᵢⱼ is a number of occurrences of the feature word in the paper dⱼ, k is a number of words in one paper, nₖⱼ is a total number of words in the paper dⱼ, is a total number of all papers in a corpus, and |{j: termᵢ∈dⱼ}| is a number of documents containing the feature word termᵢ;
wherein a formula of the K-means clustering is:
$${c}^{( i )} := arg {min}_{j} {‖ {x}^{( i )} - {μ}_{j} ‖}^{2}$$
wherein, x is a technology word group vector, μ is a technology core word vector; and a formula for calculating the technology trend is:
$$\underline{( 1 - {\sum }_{i = 1}^{p} {ϕ}_{i} {L}^{i} ) {( 1 - L )}^{d} {X}_{t} = ( 1 + {\sum }_{i = 1}^{q} {θ}_{i} {L}^{i} ) {ε}_{t}}$$
wherein, p is an autoregressive term, ϕ is a slope coefficient, L is a lag operator, d is a fractional order, X is a technical correlation, q is a corresponding number of moving average terms, θ is a moving average coefficient, and ε is a technical coefficient.

13. (canceled)

14. (canceled)

15. A technology trend prediction system, comprises an acquisition module configured for acquiring paper data, wherein the technology trend prediction system further comprises:
a processing module configured to process the paper data to generate a candidate technology lexicon;
a screening module configured to screen the candidate technology lexicon based on mutual information;
a calculation module configured to calculate an independent word forming probability of an OOV word;
an extraction module configured to extract missed words in a title by using a bidirectional long short-term memory network and a conditional random field (BI-LSTM+CRF) model; and
a prediction module configured to predict a technology trend.

16. The technology trend prediction system according to claim 15, wherein the acquisition module is further configured to construct a set of paper data;
wherein the processing module is further configured to perform a part-of-speech filtering by using an existing part-of-speech tagging, obtaining a preliminary lexicon after the part-of-speech filtering is completed, and improving OOV word discovery of the candidate technology lexicon by using a Hidden Markov Model (HMM) method; and
wherein a formula of the HMM method is:
$$\underline{log \{ P ( X \vert Y ) P ( Y ) \} = π ( {y}_{1} ) + {\sum }_{2}^{n} \{ log \{ P ( {y}_{i} \vert {y}_{i - 1} ) \} + log \{ P ( {x}_{i} \vert {y}_{i} ) \} \}}$$
wherein, x is an observation sequence, y is a state sequence, π(y₁) represents a probability that a first state is y₁, P represents a state transition probability, i represents an i-th state, and n represents a number of states.

17. (canceled)

18. (canceled)

19. (canceled)

20. The technology trend prediction system according to claim 16, wherein the screening module is further configured to calculate the mutual information of the OOV words, select a first threshold, and remove the OOV words with the mutual information lower than the first threshold, a calculation formula is:
$${MI}_{s} = \frac{P ( {t}_{1} {t}_{2} … {t}_{i} )}{{\sum }_{i} P ( {t}_{i} ) - PP ( {t}_{1} {t}_{2} … {t}_{i} )} \approx \frac{\frac{f ( {t}_{1} {t}_{2} … {t}_{i} )}{L}}{\frac{{\sum }_{i} f ( {t}_{i} )}{L} - \frac{f ( {t}_{1} {t}_{2} … {t}_{i} )}{L}}$$
wherein, t₁ t₂ . . . tᵢ represents the OOV word, tᵢ represents characters forming the OOV word, f(t₁ t₂ . . . tᵢ) represents a frequency of the OOV word appearing in a patent, L represents a total word frequency of all words in the patent, i represents the number of characters forming the OOV word, and P (t₁ t₂ . . . tᵢ) represents a probability that the t₁ t₂ . . . tᵢ appears in the patent;
the screening module is configured to compensate a result of the calculation formula with a word length when a frequency of long words is less than a frequency of short words appearing in the patent, and a compensated result is:
$$\underline{{MI}_{s} \approx \frac{f ( {t}_{1} {t}_{2} … {t}_{i} )}{{\sum }_{i} f ( {t}_{i} ) - f ( {t}_{1} {t}_{2} … {t}_{i} )} \times {N}_{i}}$$
wherein, Nᵢ=i log₂ i.

21. (canceled)

22. The technology trend prediction system according to claim 20, wherein the calculation module is further configured to select a second threshold and remove the OOV words with the independent word forming probability lower than the second suitable threshold, formulas are:
$$Ldp = p ( Lpstr \vert str ) = \frac{p ( Lpstr )}{p ( str )} = \frac{f ( Lpstr )}{f ( str )} \\ Rdp = p ( Rpstr \vert str ) = \frac{p ( Rpstr )}{p ( str )} = \frac{f ( Rpstr )}{f ( str )} \\ Idp ( str ) = 1 - dp ( pstr \vert str ) = 1 - max \{ Ldp ( str ) , Rdp ( str ) \}$$
wherein, str represents a substring, pstr represents a parent string, Rpstr represents a right parent string, Lpstr represents a left parent string, p(⋅) represents a probability that a character string appears, f(⋅) represents a frequency of the character string, Ldp represents dependence of the sub string on the left parent string, Rdp represents the dependence of the substring on the right parent string, Idp represents the independent word forming probability of the substring, and dp represents the dependence of the substring on the parent string and is a maximum value of the Idp and the Rdp.

23. The technology trend prediction system according to claim 22, wherein a training method of the BI-LSTM+CRF model comprises following sub-steps:
step 41: constructing a labeled corpus according to a technology lexicon, taking words in a title and also in the technology lexicon obtained in step 1 to step 3 as a training corpus of the BI-LSTM+CRF model, taking the other words in the title as a predicted corpus of the BI-LSTM+CRF model, and labeling the words in the title of the training corpus with B, I, and O, three types of tags, wherein B represents a beginning character of a new word, I represents an internal character of the new word, and O represents a non-technical noun word;
step 42: converting the words into word vectors, and encoding the word vectors by using the BI-LSTM model;
step 43: mapping an encoded result to a sequence vector with a dimension of a number of the tags through a fully connected layer; and
step 44: decoding the sequence vector by the CRF model.

24. The technology trend prediction system according to claim 23, wherein the extraction module is further configured to apply the trained BI-LSTM+CRF model to the predicted corpus and extract words labeled as B and I as new words discovered.

25. The technology trend prediction system according to claim 15, wherein an operation of the prediction module further comprises following sub-steps:
step 51: extracting keywords of the paper data using a technology lexicon and an existing word segmentation system;
step 52: calculating word vectors of the extracted keywords in a high dimension to obtain xₜ [symbol] ^{d}, wherein d is a spatial dimension, and [symbol] is a set of word vectors;
step 53: matching a technology word group w={w1,w2,w3 . . . } corresponding to a certain specific technology through a technical map, calculating correlated words of a word in the technology word group w in the paper data to obtain wt={w1t, w2t, w3t . . . }, wherein t is the time when the word appears for the first time same or similar in a paper;
step 54: performing K-means clustering for the correlated words generated after calculation to obtain a same or similar technology set;
step 55: obtaining a corresponding technical representation of the same or similar technology set using a weighted reverse maximum matching method, wherein different technology keywords have different weights in the technical map;
step 56: calculating a number of papers at different times for the specific technology by a Jaccard index to obtain a published time sequence of papers related with the specific technology, and a formula of the Jaccard index is:
$$( w 1 , w 2 ) = \frac{w 1 ⋂ w 2}{w 1 ⋃ w 2}$$
where, w1 is a keyword in the same or similar technology set, and w2 is a keyword in the paper;
step 57: calculating the technology trend by an ARIMA model; and
step 58: using an unweighted maximum matching and edge cutting algorithm to obtain a technology relevance without a communication to calculate a technology change trend between technology clusters.

26. The technology trend prediction system according to claim 25,
wherein the keywords are extracted using a weighted term frequency-inverse document frequency (TF-IDF) formula:
$$weght ( {T}_{ij} ) = {tf}_{ij} \times {idf}_{j} = \frac{{n}_{ij}}{{\sum }_{k} {n}_{kj}} \times log \frac{\vert D \vert}{\vert \{ j : {term}_{i} ∈ {d}_{j} \} \vert + 1}$$
wherein, Tᵢⱼ is a feature word, tfᵢⱼ is a feature word frequency, id fⱼ is an inverse document frequency, nᵢⱼ is a number of occurrences of the feature word in the paper dⱼ, k is the number of words in one paper, nₖⱼ is a total number of words in the paper dⱼ, D is a total number of all papers in a corpus, and |{j: termᵢεdⱼ}| is a number of documents containing the feature word termᵢ;
wherein a formula of the K-means clustering is:
$$\underline{{c}^{( i )} := arg {min}_{j} {‖ {x}^{( i )} - {μ}_{j} ‖}^{2}}$$
wherein, x is a technology word group vector, μ is a technology core word vector;
a formula for calculating the technology trend is:
$$\underline{( 1 - {\sum }_{i = 1}^{p} {ϕ}_{i} {L}^{i} ) {( 1 - L )}^{d} {X}_{t} = ( 1 + {\sum }_{i = 1}^{q} {θ}_{i} {L}^{i} ) {ε}_{t}}$$
wherein, p is an autoregressive term, ϕ is a slope coefficient, L is a lag operator, d is a fractional order, X is a technical correlation, q is a corresponding number of moving average terms, θ is a moving average coefficient, and ε is a technical coefficient.

27. (canceled)

28. (canceled)
